(19) United States
(12) Patent Application Publication
(10) Pub. No.: US 2004/0026145 A1
(43) Pub. Date: Feb. 12, 2004

(54) Positioning structure of dynamic scooter

(76) Inventor: Mey-Chu Lan, Taipei Hsien (TW)

Correspondence Address: Mey-Chu Lan, 235 Chung - Ho, Box 8-24, Taipei, TW

(21) Appl. No.: 10/634,696

(22) Filed: Aug. 6, 2003

Related U.S. Application Data
(63) Continuation-in-part of application No. 09/924,750, filed on Aug. 7, 2001, now Pat. No. 6,619,679.

(51) Int. Cl. B62K 11/00; B62M 7/00

(52) U.S. Cl. 180/180; 180/220

(57) ABSTRACT

A positioning structure of a dynamic scooter comprises a handle supporter, a linkage seat, and a bicycle body. A lower end of the handle supporter is engaged with a linkage. A bottom end of the bicycle body has a front wheel and a rear end of the bicycle body has a rear wheel. The treadle is installed at an upper side of the bicycle body; and a front end of the treadle has an ear. The ear is connected to the stud of the linkage. The treadle is positioned to the bicycle body. When the treadle is pivotally lifted, the bicycle body pivotally rotates and is positioned. A bottom of the treadle is installed with a first buckle and an upper side of the bicycle body is installed with a second buckle so that the treadle is tightly adhered to the bicycle body by the buckles.

The invention is a continuation in part (CIP) of the U.S. patent Ser. No. 09/924,750, which is assigned to the invention of the present invention. Thus, contents in the specification of the U.S. patent Ser. No. 09/924,750 is incorporated in this specification of the invention as a part of the invention.

### FIELD OF THE INVENTION

The present invention relates to scooter, and particularly to a positioning structure of a dynamic scooter; wherein the scooter has a firm structure so that the scooter is stable in moving or turning direction and update or charge of batteries can be performed easily.

### BACKGROUND OF THE INVENTION

The present invention relates to a U.S. patent Ser. No. 09/924,750, as shown in FIGS. 1 and 2. In this prior art, a treadle is installed at a bicycle body. Two front sides of the treadle are formed with respective axial ears. The treadle is installed to the bicycle body for being treaded by the user. Batteries are installed to the treadle. If it is desired to update or charge the batteries, the treadle can be pivotally lifted. However, since the ears are installed at the two front sides, they are easily damaged. The rear end of the treadle only locates on the bicycle body so that the connection of the two are loose. When the scooter turns its moving direction or moves with a high speed, the treadle will vibrate so as to affect the control of the scooter. Thereby, the scooter easily falls down due to outer force. Moreover, batteries fall out so as to generate accidents.

### SUMMARY OF THE INVENTION

Accordingly, the primary object of the present invention is to provide a positioning structure of a dynamic scooter, wherein the scooter has a firmly structure so that the scooter is stable in moving or turning direction and update or charge of batteries can be performed easily.

To achieve above objects, the present invention provides a positioning structure of a dynamic scooter comprising a handle supporter, a linkage seat, a bicycle body. A lower end of the handle supporter is engaged with a linkage. A bottom end of the bicycle body has a front wheel and a rear end of the bicycle body having a rear wheel. The treadle is installed at an upper side of the bicycle body; and a front end of the treadle has an ear. The ear is connected to the stud of the linkage, the treadle being positioned to the bicycle body. When the treadle is pivotally lifted, the bicycle body pivotally rotates and positioned. A bottom of the treadle is installed with a first buckle and an upper side of the bicycle body is installed with a second buckle so that the treadle is tightly adhered to the bicycle body by the buckles.

The various objects and advantages of the present invention will be more readily understood from the following detailed description when read in conjunction with the appended drawing.

### BRIEF DESCRIPTION OF THE DRAWINGS

FIG. 1 is an assembled perspective view of the prior art.

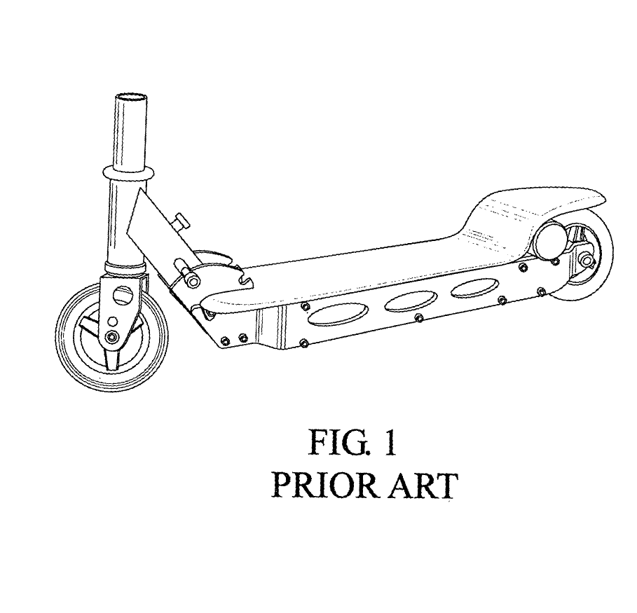

FIG. 2 shows one operation of the prior art illustrated in FIG. 1.

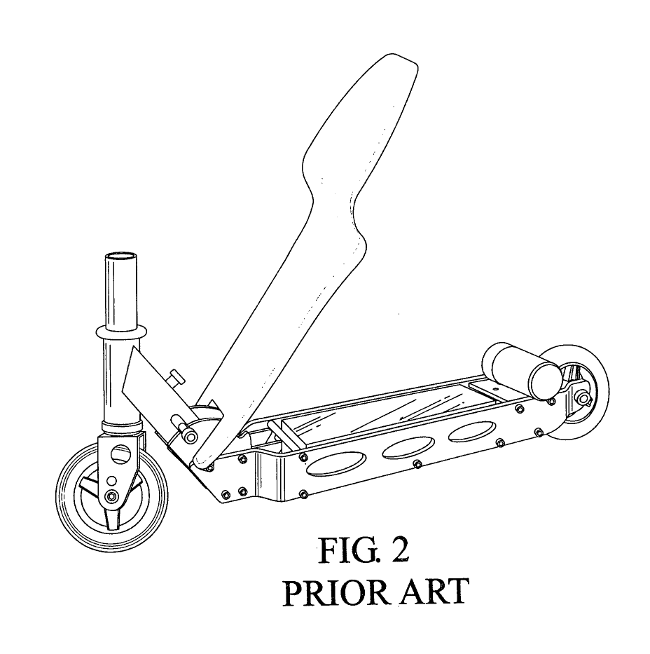

FIG. 3 is an assembled perspective view of the present invention.

FIG. 4 is a plane view showing that the treadle is located on the bicycle body according to the present invention.

FIG. 5 is a schematic view showing the treadle being pivotally lifted according to the present invention.

FIG. 6 is an assembled perspective view of another embodiment of the present invention.

FIG. 7 is a plane view showing that the treadle is located on the bicycle body according to the present invention.

FIG. 8 is a schematic view showing the lifting of the treadle in another embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

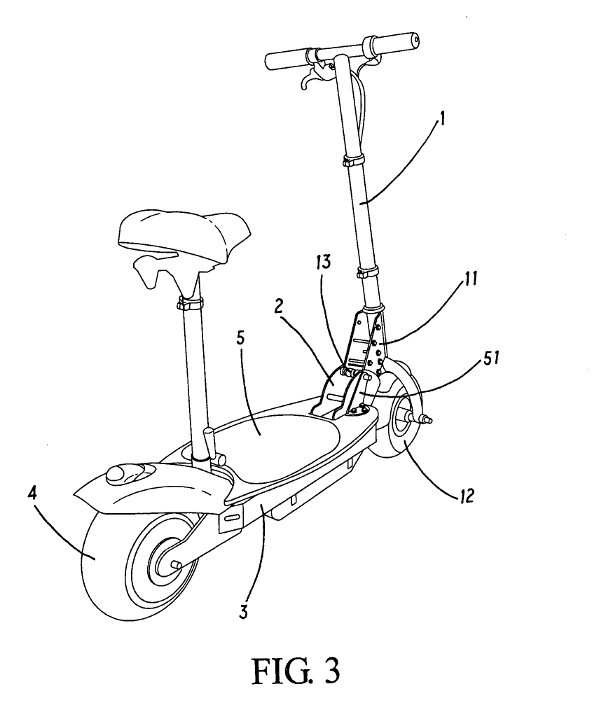

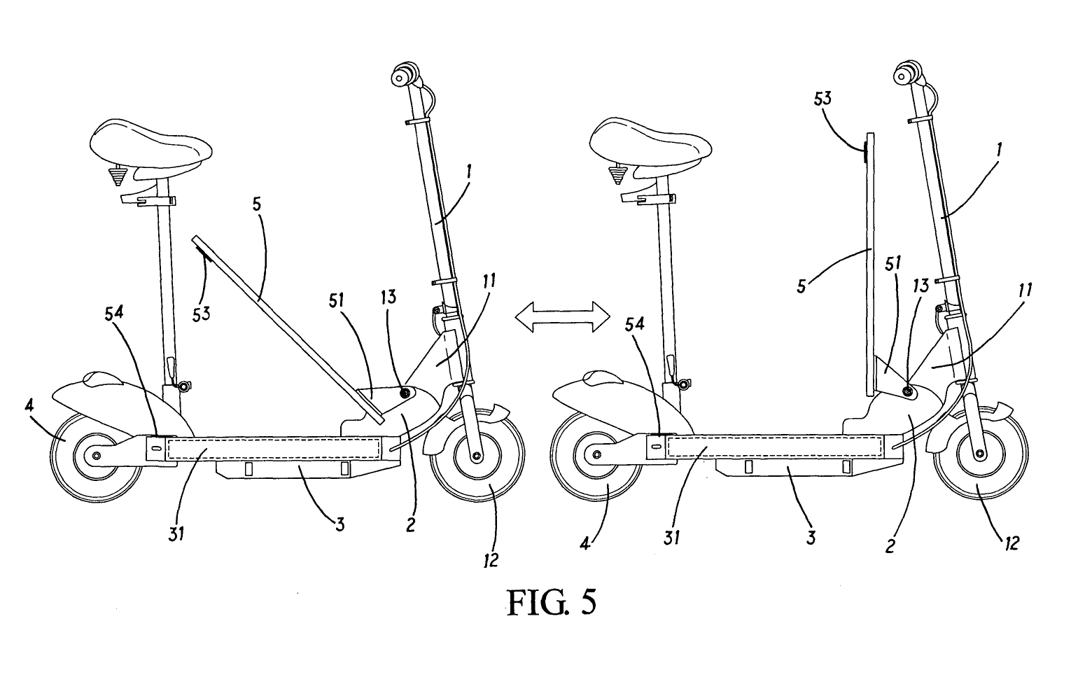

With reference to FIGS. 3 to 5, the positioning structure of a dynamic scooter of the present invention is illustrated. The scooter includes a handle supporter 1, a linkage seat 2, and a bicycle body 3. A lower end of the handle supporter 1 is engaged with a linkage 11. A bottom end of the bicycle body 3 has a front wheel 12 and the rear end of the bicycle body 3 has a rear wheel 4. The treadle 5 is installed at an upper side of the bicycle body 3. A front end of the treadle has an ear 51. The ear 5 is connected to the stud 13 of the linkage 11. The treadle 5 is positioned to the bicycle body 3. When the treadle 5 is pivotally lifted, the bicycle body 3 pivotally rotates and is positioned.

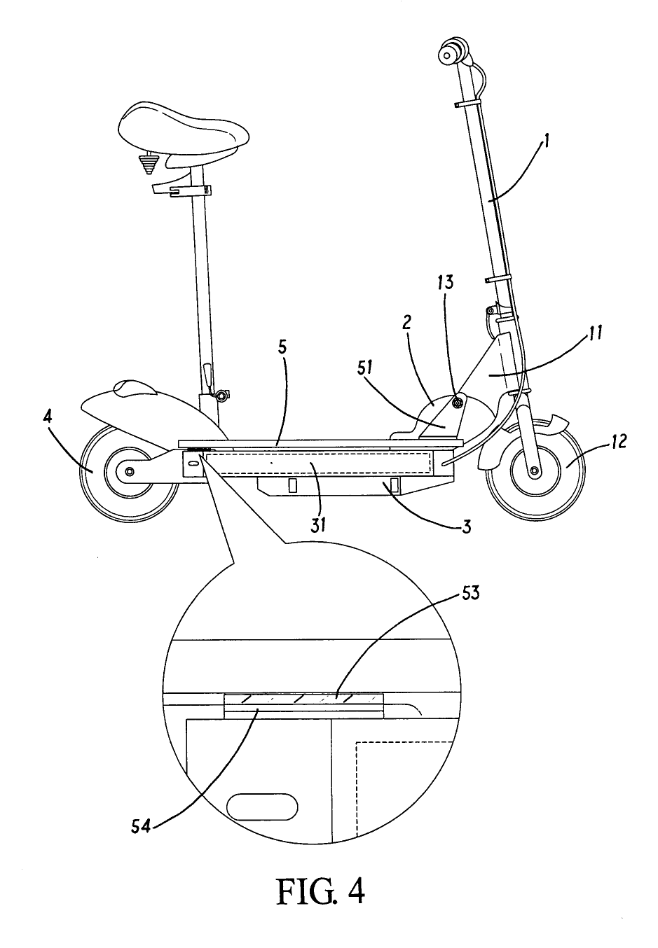

Referring to FIG. 4, a bottom of the treadle 5 is installed with a buckle 53 and an upper side of the bicycle body 3 is installed with a buckle 54 so that the treadle 5 can be tightly adhered to the bicycle body 3 by the buckles 53 and 54. Thus the treadle is firmly positioned and has a high stability. Moreover, the control of the treadle is stable and easy. The treadle 5 is tightly installed at the upper side of the bicycle body 3. Therefore, the batteries 31 within the treadle 3 will not fall out. If it is desired to update or charge batteries, the treadle 3 can be pivotally lifted for update and charge. Thereby, the operation is convenient.

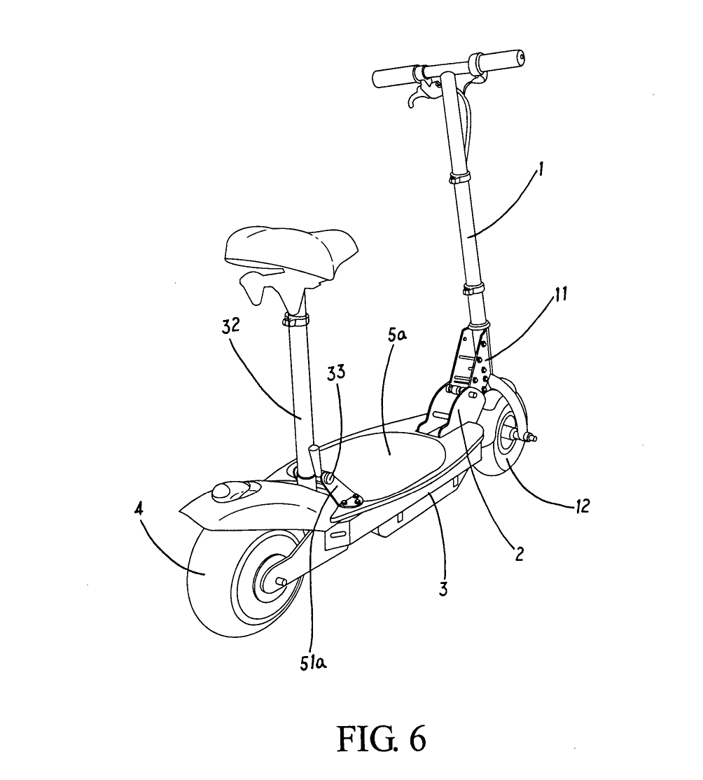

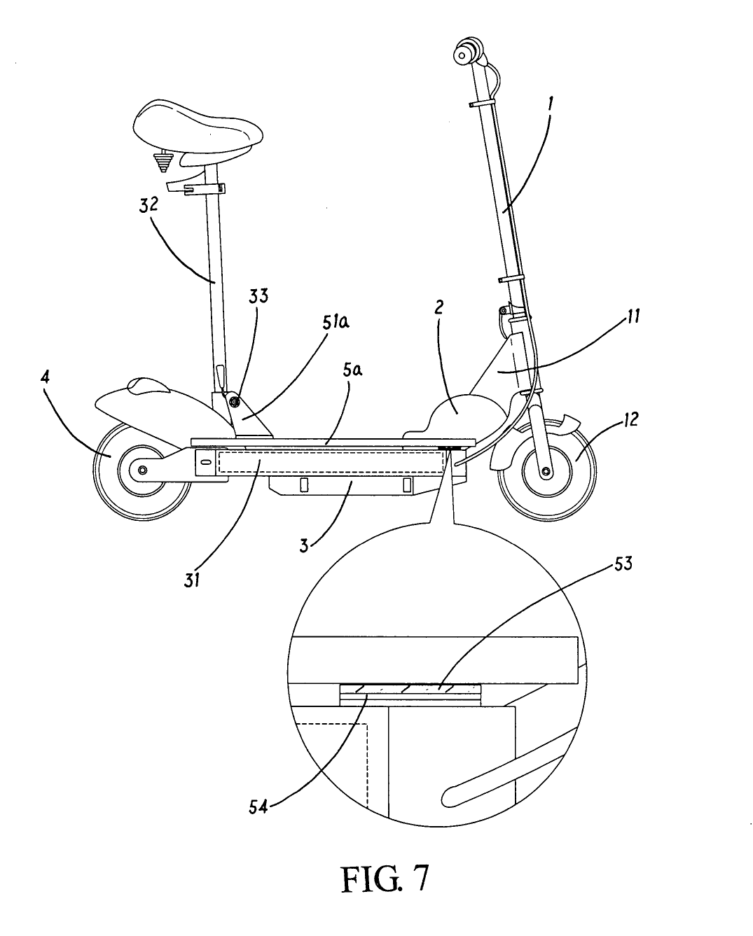

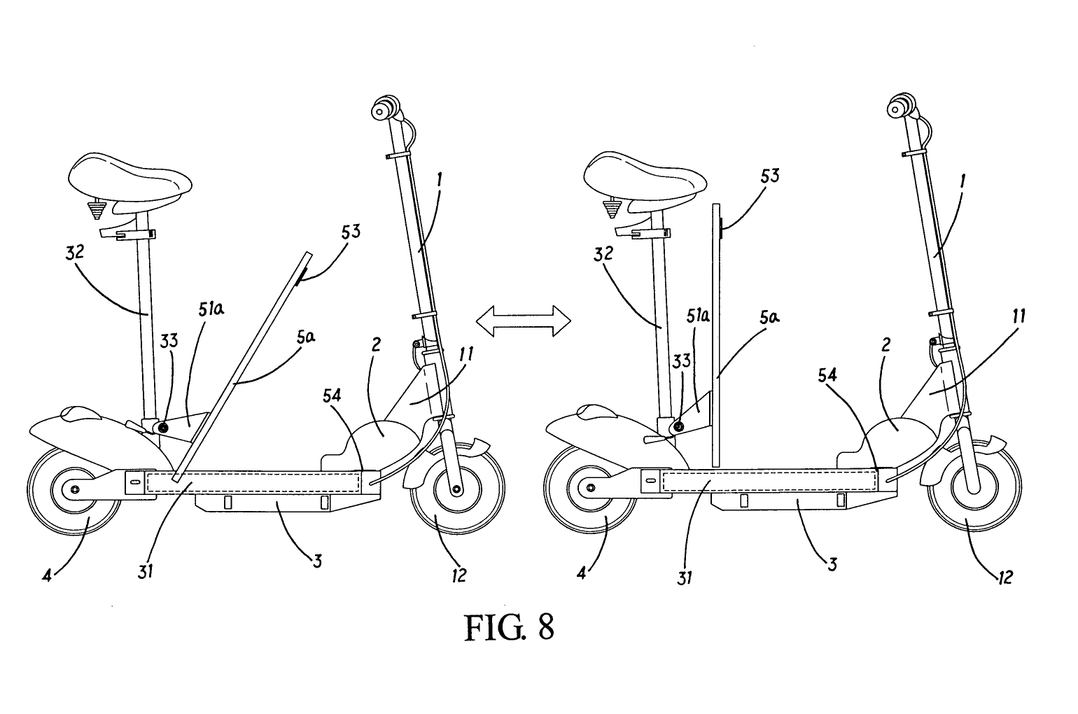

With reference to FIGS. 6 to 8, in this embodiment, the treadle 5a is installed at an upper side of the bicycle body 3, and a rear end thereof has an ear 51a. The ear 51a is pivotally connected to a stud 33 at a lower end of a stand tube 32 extended from a rear end of the bicycle body 3, the treadle 5a can be positioned to the bicycle body 3. When the treadle 5a is lifted pivotally, the treadle 5a pivotally rotates with respect to the bicycle body 3. Thereby, not only used in various kinds of scooters, the connection of the ear 51a and the stand tube 32 is selectable.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A positioning structure of a dynamic scooter comprising a handle supporter, a linkage seat, and a bicycle body; a lower end of the handle supporter being engaged with a linkage; a bottom end of the bicycle body having a front wheel and a rear end of the bicycle body having a rear wheel; the treadle being installed at an upper side of the bicycle body; a front end of the treadle has an ear; the ear being connected to a stud of the bicycle body; the treadle being positioned to the bicycle body; wherein when the treadle is pivotally lifted, the bicycle body pivotally rotates and is positioned.

2. The positioning structure of a dynamic scooter as claimed in claim 1, wherein a bottom of the treadle is installed with a first buckle and an upper side of the bicycle body is installed with a second buckle so that the treadle is tightly adhered to the bicycle body by the first and second buckles.

3. The positioning structure of a dynamic scooter as claimed in claim 1, wherein the stud of the bicycle body is installed on the linkage.

4. The positioning structure of a dynamic scooter as claimed in claim 1, wherein the stud of the bicycle body is installed at a lower end of a stand tube of a seat.
